(19) United States
(12) Patent Application Publication
(10) Pub. No.: US 2026/0285183 A1
(43) Pub. Date: Sep. 24, 2026

(54) CHARGING AND DISCHARGING MANAGEMENT DEVICE AND CHARGING AND DISCHARGING MANAGEMENT METHOD

(71) Applicant: HONDA MOTOR CO., LTD., Tokyo (JP)

(72) Inventor: Takayuki Sakurai, Tokyo (JP)

(21) Appl. No.: 19/445,709

(22) Filed: Jan. 12, 2026

(30) Foreign Application Priority Data
Mar. 19, 2025 (JP) 2025-046035

(51) Int. Cl. B60L 53/62; B60L 53/66; B60L 58/12

(52) U.S. Cl. CPC B60L 53/62; B60L 53/66; B60L 58/12

(57) ABSTRACT

A charging and discharging management device includes a charging and discharging control unit that performs adjustment of an exchange of electric power between the battery and the external electric power source. The charging and discharging control unit controls such that the battery is charged until a state of charge of a battery reaches an allowable reference value in a case in which a vehicle usage schedule has not been input and the state of charge of the battery is less than the allowable reference value, and controls such that the exchange of the electric power between the battery and an external electric power source is executed preferentially in a case in which the vehicle usage schedule has not been input and the state of charge of the battery is equal to or greater than the allowable reference value.

### CROSS-REFERENCE TO RELATED APPLICATION

Priority is claimed on Japanese Patent Application No. 2025-046035, filed Mar. 19, 2025, the content of which is incorporated herein by reference.

### BACKGROUND OF THE INVENTION

### Field of the Invention

The present invention relates to a charging and discharging management device and a charging and discharging management method.

### Description of Related Art

In recent years, research has been progressing on a demand response (hereinafter referred to as “DR”) mechanism that balances the supply and demand of electric power by controlling the charging and discharging of a battery installed in a vehicle using a vehicle-to-grid (V2G) technology for supplying electric power from a battery installed in a vehicle to an electric power grid. In a system that realizes such DR, the charging and discharging of the battery is controlled taking into account a vehicle usage schedule previously set by the user, so as to realize participation in DR within a range that does not affect this vehicle usage schedule (see, for example, Patent Document 1 below).

[Patent Document 1] Japanese Unexamined Patent Application, First Publication No. 2023-134156.

### SUMMARY OF THE INVENTION

In the related art described above, in a case in which a vehicle usage schedule is not set due to reasons such as the user forgetting to set it, charging and discharging control will be performed with priority given to a demand response plan (hereinafter referred to as a “DR plan”). However, no specific study has been conducted on a method for effectively controlling the DR under such conditions. As a result of this type of charging and discharging control that prioritizes the DR plan, there have been cases in which the usage of a vehicle by the user has been affected, such as a case in which a state of charge of a battery is insufficient when the user tries to start the usage of a vehicle. It is possible to control the system such that participation in DR does not occur in a case in which the user has not set an action plan, but this could make it difficult to efficiently utilize a battery resource and could reduce the opportunities of the user to participate in DR.

Aspects of the present invention have been made in consideration of these circumstances, and one of their objects is to provide a charging and discharging management device and a charging and discharging management method that can improve user convenience and resource utilization in controlling DR.

In order to solve the above problems, the present invention employs the following configuration.
(1) According to an aspect of the present invention, there is provided a charging and discharging management device including an acquisition unit that acquires input information on a vehicle usage schedule from a user of a vehicle, an allowable reference value which is set by the user and is a reference of a state of charge for whether or not to allow an exchange of electric power between a battery of the vehicle and an external electric power source, and a state of charge of the battery, a determination unit that determines whether or not the vehicle usage schedule has been input on the basis of the input information, and a charging and discharging control unit that controls charging and discharging of the battery to perform adjustment of an exchange of electric power between the battery and the external electric power source, wherein the charging and discharging control unit controls such that the battery is charged until the state of charge of the battery reaches the allowable reference value in a case in which the vehicle usage schedule has not been input and the state of charge of the battery is less than the allowable reference value, and controls such that the exchange of the electric power between the battery and the external electric power source is executed preferentially in a case in which the vehicle usage schedule has not been input and the state of charge of the battery is equal to or greater than the allowable reference value.
(2) In the above aspect (1), the allowable reference value may be a single value set by the user.
(3) In the above aspect (1), the allowable reference value may include a plurality of values set by the user for each period.
(4) In any one of the above aspects (1) to (3), the charging and discharging control unit may perform the adjustment such that a vehicle, for which no vehicle usage schedule has been input, of a plurality of vehicles has a higher priority for participating in the exchange of the electric power between the battery and the external electric power source.
(5) Any one of the above aspects (1) to (3) may further include a remuneration management unit that manages a remuneration for the user according to a performance of participation in the exchange of the electric power between the battery and the external electric power source, wherein the remuneration management unit may provide a remuneration to the user in a case in which the vehicle is waiting to participate in a state where the vehicle is able to exchange electric power, and wherein a remuneration in a case in which the vehicle is waiting to participate may be lower than a remuneration in a case in which the vehicle has a performance of participation.
(6) In any one of the above aspects (1) to (3), in a case in which the allowable reference value is not set by the user, the charging and discharging control unit may perform the adjustment using a predetermined reference value as the allowable reference value.
(7) In any one of the above aspects (1) to (3), in a case in which the vehicle usage schedule has been input, the charging and discharging control unit may perform the adjustment on the basis of the vehicle usage schedule.
(8) According to an aspect of the present invention, there is provided a charging and discharging management method causing a computer of a charging and discharging management device to execute acquiring input information on a vehicle usage schedule by a user of a vehicle, an allowable reference value which is set by the user and is a reference of a state of charge for whether or not to allow an exchange of electric power between a battery of the vehicle and an external electric power source, and a state of charge of the battery, determining whether or not the vehicle usage schedule has been input on the basis of the input information, controlling charging and discharging of the battery to perform adjustment of an exchange of electric power between the battery and the external electric power source, controlling such that the battery is charged until the state of charge of the battery reaches the allowable reference value in a case in which the vehicle usage schedule has not been input and the state of charge of the battery is less than the allowable reference value, and controlling such that the exchange of the electric power between the battery and the external electric power source is executed preferentially in a case in which the vehicle usage schedule has not been input and the state of charge of the battery is equal to or greater than the allowable reference value.

According to the above aspects (1) to (8), it is possible to improve user convenience and resource utilization in controlling the DR. Even in a case in which the vehicle usage schedule has not been input by the user, the vehicle can be made to participate in the DR (or used as a spare resource), and thus it is possible to improve resource utilization. Since inputting the vehicle usage schedule is not a requirement for participating in the DR, it is possible to reduce the burden and stress on the user regarding the inputting. Since the minimum state of charge required for traveling is secured, it is possible to prevent any impact on subsequent use of the vehicle.

According to the above aspect (4), by performing the adjustment such that a vehicle for which no vehicle usage schedule has been input (a vehicle for which start of usage is not known) has a higher priority for participating in the DR, it is possible to use resources efficiently and increase resource utilization rate.

According to the above aspect (5), by providing a remuneration to the user even in a case in which the vehicle is waiting in a state where the vehicle can participate in the DR, the opportunities of the user to receive a remuneration can be increased, and the motivation of the user to participate in the DR can be improved.

### BRIEF DESCRIPTION OF THE DRAWINGS

FIG. 1 is a diagram showing an example of a configuration of a charging and discharging management system that includes a charging and discharging management device according to an embodiment.

FIG. 2 is a diagram showing an overview of DR control according to the embodiment (a graph showing a relationship between time and a state of charge of a battery mounted on a vehicle).

FIG. 3 is a functional block diagram showing an example of a configuration of a terminal device according to the embodiment.

FIG. 4 is a flowchart showing an example of a flow of setting processing of the charging and discharging management device according to the embodiment.

FIG. 5 is a diagram showing an example of a vehicle usage schedule setting screen displayed on the terminal device according to the embodiment.

FIG. 6 is a diagram showing an example of an allowable reference value setting screen displayed on the terminal device according to the embodiment.

FIG. 7A is a diagram showing an example of an allowable reference value according to the embodiment.

FIG. 7B is a diagram showing another example of the allowable reference value according to the embodiment.

FIG. 7C is a diagram showing still another example of the allowable reference value according to the embodiment.

FIG. 8 is a flowchart showing an example of a flow of DR control of the charging and discharging management device according to the embodiment.

FIG. 9 is a flowchart showing an example of a flow of DR control based on the allowable reference value according to the embodiment.

### DETAILED DESCRIPTION OF THE INVENTION

Hereinafter, an embodiment of a charging and discharging management device and a charging and discharging management method of the present invention will be described with reference to the drawings.

### Overall configuration

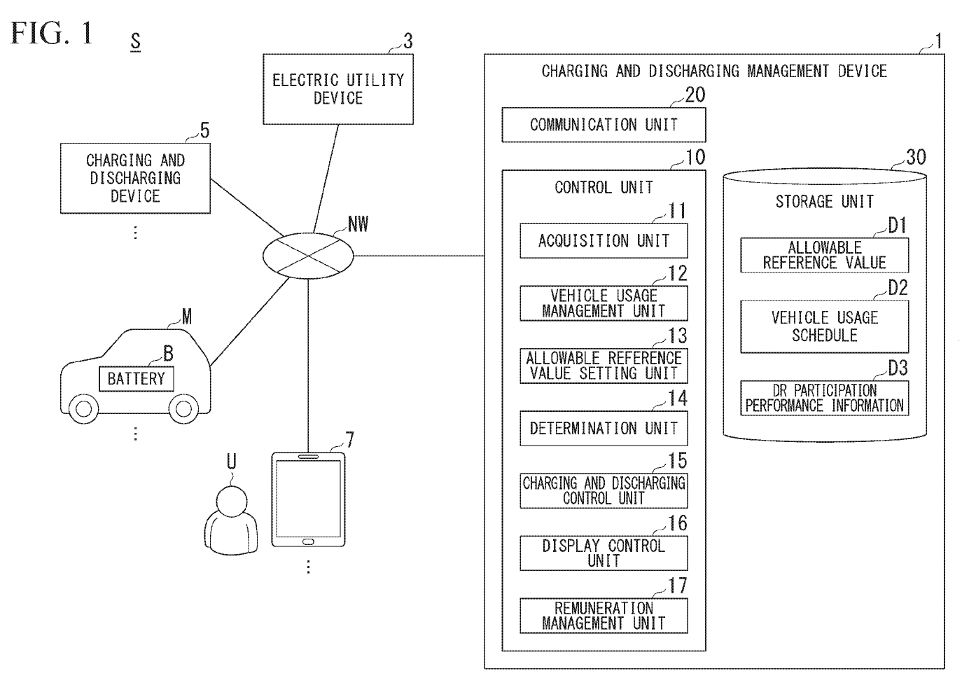

FIG. 1 is a diagram showing an example of a configuration of a charging and discharging management system S that includes a charging and discharging management device 1 according to the embodiment. The charging and discharging management system S performs demand response control (hereinafter referred to as “DR control”) by controlling the charging and discharging of the battery using a V2G technology for supplying electric power from a storage battery (hereinafter referred to as a “battery”) mounted on a vehicle to an electric power grid.

### Overview

FIG. 2 is a diagram showing an overview of the DR control according to the embodiment (a graph showing a relationship between time and a state of charge (SOC) of a battery mounted on a vehicle). In this example, the user sets an allowable reference value (also referred to as a “DR usable SOC”), which is a reference of the state of charge for whether or not to allow an exchange of the electric power between the battery of the vehicle and an external electric power source (an electric power trading market, an electric power grid, a grid electric power source), to “50%.” Here, the SOC in the range where the DR usable SOC is 0% to 50% is referred to as a “traveling priority SOC,” and the SOC in the range where the DR usable SOC is 50% to 100% is referred to as a “demand response priority SOC (hereinafter referred to as a “DR priority SOC”).” The traveling priority SOC is in an SOC range in which the electric power stored in the battery is used preferentially for traveling of the vehicle. On the other hand, the DR priority SOC is in an SOC range in which the electric power (or the void space) stored in the battery is used preferentially for the DR control.

The vehicle starts moving at time t1, returns home at time t2, and a charging port of the vehicle is fitted to a charging plug provided at a residence, and thereafter, the vehicle is incorporated into the DR control. Between time t1 and time t2, the SOC of the battery decreases as the vehicle travels (EV traveling). Thereafter, at time t2, since the SOC of the battery is included in the traveling priority SOC, charging of the battery (forced recovery charging) is started to prioritize the traveling of the vehicle (ensuring a minimum state of charge), and the DR control is not performed at this time. Thereafter, at time t3, the SOC of the battery is recovered to the DR usable SOC (50%) through charging, and when the SOC of the battery enters the DR priority SOC, the DR control is started. Thereafter, at time t4, when control to increase electric power demand (hereinafter referred to as “increasing DR”) is started in response to a request from the electric utility or the like, the battery is charged and the SOC increases. Thereafter, at time t5, when control to decrease electric power demand (hereinafter referred to as “decreasing DR”) is started in response to a request from the electric utility or the like, the battery is discharged and the SOC decreases. In this way, the charging and discharging management system S can switch between charging the battery and subjecting the battery to demand response control on the basis of the allowable reference value (the DR usable SOC) set as described above.

Returning to FIG. 1, the charging and discharging management system S includes, for example, the charging and discharging management device 1, an electric utility device 3, one or more charging and discharging devices 5, one or more terminal devices 7, and one or more vehicles M. The devices, the terminal, the vehicle, and the like of the charging and discharging management system S are connected to each other so as to be able to communicate with each other via a communication network NW. The communication network NW is, for example, the Internet, a mobile communication network, a wide area network (WAN), a local area network (LAN), a cellular network, or the like.

The charging and discharging management device 1 performs overall control of the charging and discharging management system S. For example, the charging and discharging management device 1 controls the charging and discharging of a battery B mounted on the vehicle M connected to the charging and discharging device 5 in accordance with a demand response plan (hereinafter referred to as a “DR plan”) received from the electric utility device 3. The charging and discharging management device 1 will be described in detail later.

The electric utility device 3 is used by businesses that supply electricity, such as electricity transmission and distribution businesses and electricity retail businesses. The electric utility device 3 creates a DR plan according to the electric power storage status and notifies consumers of electric power such as companies and homes. In the charging and discharging management system S, the electric utility device 3 transmits the DR plan to the charging and discharging management device 1 via the communication network NW.

The charging and discharging device 5 (also referred to as “charging and discharging equipment”) charges and discharges the battery B mounted on the vehicle M. The charging and discharging device 5 is installed, for example, at the residence of a user U of the vehicle M or at a public charging station. The charging and discharging device 5 charges the battery B using grid energy supplied from a general power distribution network (a grid, a commercial power source) or recyclable energy generated by a power generation device provided in the residence or the like. The charging and discharging device 5 discharges the battery B by returning the electric power stored in the battery B to the grid.

The vehicle M may be, for example, a four-wheeled, two-wheeled, or three-wheeled vehicle. The drive source of the vehicle is, for example, an electric motor, or a combination of an electric motor and an internal combustion engine such as a diesel engine or a gasoline engine. The electric motor operates using discharged electric power from the battery B, which is a secondary battery or a fuel cell, or electric power generated by a generator connected to the internal combustion engine. The vehicle M may be, for example, an electric vehicle, a hybrid vehicle, a fuel cell vehicle, an electric motorcycle, or the like.

For example, the vehicle M is used by the user U (also referred to as a “driver”). When the user U returns to his or her residence, the user U connects (fits) the charging plug of the charging and discharging device 5 installed in the residence to the charging port of the vehicle M, thereby enabling the charging and discharging of the vehicle M. Alternatively, the user U goes to a charging station and connects (fits) the charging plug of the charging and discharging device 5 installed in the charging station to the charging port of the vehicle M, thereby enabling the charging and discharging of the vehicle M.

The terminal device 7 is used by the user U, for example. The terminal device 7 is, for example, a smartphone, a tablet terminal, a general-purpose personal computer, or the like. The terminal device 7 may be connected to the vehicle M and function as an in-vehicle device. The terminal device 7 transmits information input by the user U to the charging and discharging management device 1 and the like. The terminal device 7 outputs the information transmitted from the charging and discharging management device 1 and notifies the user U of the information. The terminal device 7 executes a pre-installed demand response application (hereinafter referred to as a “DR application”) to realize various functions for participating in the DR control. These various functions may be realized using a general-purpose application program such as a web browser that runs on the terminal device 7. The terminal device 7 will be described in detail later.

### Charging and discharging management device

Next, the configuration of the charging and discharging management device 1 will be described in detail. As shown in FIG. 1, the charging and discharging management device 1 includes, for example, a control unit 10, a communication unit 20, and a storage unit 30.

The control unit 10 controls the overall operation of the charging and discharging management device 1. The control unit 10 includes, for example, an acquisition unit 11, a vehicle usage management unit 12, an allowable reference value setting unit 13, a determination unit 14, a charging and discharging control unit 15, a display control unit 16, and a remuneration management unit 17. Each functional unit of the control unit 10 is realized by, for example, a hardware processor (a computer) such as a central processing unit (CPU) executing a program (software). Some or all of these components may be realized by hardware such as a large scale integration (LSI), an application specific integrated circuit (ASIC), a field-programmable gate array (FPGA), a graphics processing unit (GPU), or a system on chip (SOC), or may be realized by software and hardware in cooperation. The charging and discharging management device 1 is not limited to a single device, and each functional unit of the control unit 10 may be realized by a plurality of devices in cooperation.

The acquisition unit 11 acquires various types of information from external devices via the communication network NW. The acquisition unit 11 acquires various types of information stored in the storage unit 30. For example, the acquisition unit 11 acquires input information on the vehicle usage schedule from the user U of the vehicle M, the allowable reference value set by the user U, and the state of charge of the battery B. The acquisition unit 11 is an example of an “acquisition unit.”

The vehicle usage management unit 12 manages the vehicle usage schedule of the vehicle M. For example, the vehicle usage management unit 12 associates the vehicle usage schedule input by the user U via the terminal device 7 with the user U (or the vehicle M) and registers the input vehicle usage schedule as a vehicle usage schedule D2 stored in the storage unit 30. The vehicle usage management unit 12 is an example of a “vehicle usage management unit.”

The allowable reference value setting unit 13 sets the allowable reference value. For example, the allowable reference value setting unit 13 associates the allowable reference value input by the user U via the terminal device 7 with the user U (or the vehicle M) and registers the input allowable reference value as an allowable reference value D1 stored in the storage unit 30. The allowable reference value setting unit 13 is an example of an “allowable reference value setting unit.”

The determination unit 14 determines whether or not the vehicle usage schedule of the user U has been input, which is a determination target, on the basis of the vehicle usage schedule D2. The determination unit 14 is an example of a “determination unit.”

The charging and discharging control unit 15 controls the charging and discharging of the battery B on the basis of the determination result of whether or not the vehicle usage schedule has been input, the allowable reference value, and the state of charge of the battery B, thereby perform adjustment of the exchange of the electric power between the battery B and the external electric power source (for example, the electric power grid or the electricity trading market). In a case in which the vehicle usage schedule has not been input and the state of charge of the battery B is less than the allowable reference value, the charging and discharging control unit 15 performs control for charging the battery B until the state of charge of the battery B reaches the allowable reference value. In a case in which the vehicle usage schedule has not been input and the state of charge of the battery B is equal to or greater than the allowable reference value, the charging and discharging control unit 15 controls such that the exchange of the electric power between the battery B and the electric power grid is executed preferentially over the charging of the battery B. The charging and discharging control unit 15 may perform adjustment such that a vehicle M, for which no vehicle usage schedule has been input, of a plurality of vehicles M has a higher priority for participating in the exchange of the electric power between the battery B and the electric power grid. In a case in which the allowable reference value is not set by the user U, the charging and discharging control unit 15 may perform adjustment using a predetermined reference value (for example, the DR usable SOC: 50% or the like) as the allowable reference value. The charging and discharging control unit 15 is an example of a “charging and discharging control unit.”

The display control unit 16 performs control for displaying a display unit of the terminal device 7. The display control unit 16 generates notification information (information indicating a display content) for the user on the basis of the processing results of the various functions of the control unit 10 and transmits the generated notification information to the terminal device 7. As a result, various types of information are displayed on the display unit of the terminal device 7. The display control unit 16 is an example of a “display control unit.”

The remuneration management unit 17 manages a remuneration for the user U according to a performance of participation in the exchange of the electric power between the battery B and the electric power grid. The remuneration management unit 17 provides a remuneration to the user U not only in a case in which the vehicle M participates in the exchange of the electric power, but also in a case in which the vehicle M is waiting to participate in a state where the vehicle M is able to exchange electric power. The remuneration in a case in which the vehicle M is waiting to participate may be set lower than the remuneration in a case in which the vehicle M has a performance of participation in the DR.

The communication unit 20 communicates with the external devices such as the electric utility device 3, the charging and discharging device 5, the terminal device 7, and the vehicle M via the communication network NW. The communication unit 20 is, for example, a network card for connecting to the communication network NW.

The storage unit 30 stores various types of information necessary for the DR control. The storage unit 30 may be realized by, for example, an HDD, a flash memory, an electrically erasable programmable read only memory (EEPROM), a read only memory (ROM), a random access memory (RAM), or the like. The storage unit 30 stores, for example, the allowable reference value D1 (the DR usable SOC), the vehicle usage schedule D2, DR participation performance information D3, and the like. The storage unit 30 may be realized by another storage device, such as an external storage server device, connected via the communication network NW.

### Terminal Device

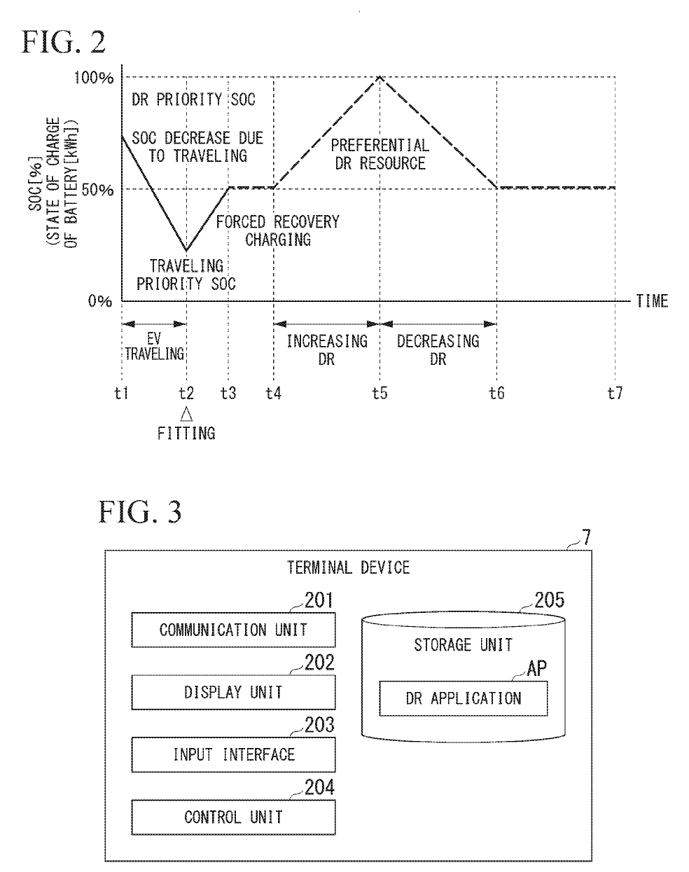

FIG. 3 is a functional block diagram showing an example of a configuration of the terminal device 7 according to the embodiment. The terminal device 7 includes, for example, a communication unit 201, a display unit 202, an input interface 203, a control unit 204, and a storage unit 205.

The communication unit 201 communicates with the charging and discharging management device 1, the external devices such as the electric utility device 3, the charging and discharging device 5, and the vehicle M via the communication network NW. The communication unit 201 is, for example, a network card for connecting to the communication network NW.

The display unit 202 displays various types of information related to the DR control. The display unit 202 displays images generated by the control unit 204, a graphical user interface (GUI) for receiving various input operations from the user U, and the like. For example, the display unit 202 is a liquid crystal display (LCD), an organic electro luminescence (EL) display, or the like.

The input interface 203 receives various input operations from the user U, converts the received input operations into electrical signals, and outputs the electrical signals to the control unit 204. For example, the input interface 203 includes a touch panel, a keyboard, a mouse, and the like.

The control unit 204 controls the overall operation of the terminal device 7. For example, the control unit 204 executes a DR application AP stored in the storage unit 205 to realize various functions for participating in the DR control. For example, the control unit 204 realizes a vehicle usage schedule input function, an allowable reference value setting function, a remuneration management function, and the like.

The storage unit 205 stores various types of information related to the DR. The storage unit 205 is realized by, for example, an HDD, a flash memory, an EEPROM, a ROM, a RAM, or the like. The storage unit 205 stores, for example, the DR application AP and the like.

### Processing flow

### Setting processing

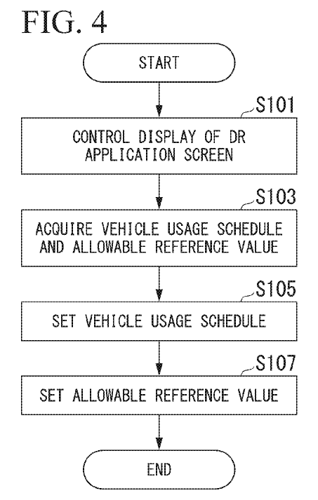

Next, the processing of the charging and discharging management device 1 will be described. FIG. 4 is a flowchart showing an example of a flow of setting processing of the charging and discharging management device 1 according to the embodiment. The processing shown in FIG. 4 is started, for example, when the user U operates the terminal device 7 to activate the DR application AP.

First, in response to a request transmitted from the terminal device 7, the display control unit 16 transmits information about a screen for inputting various types of information related to the DR to the terminal device 7 (step S101). For example, the display control unit 16 transmits screen information for setting the vehicle usage schedule, screen information for setting the allowable reference value, and the like to the terminal device 7. As a result, various screens (a vehicle usage schedule setting screen, an allowable reference value setting screen, and the like) are displayed on the display unit 202 of the terminal device 7.

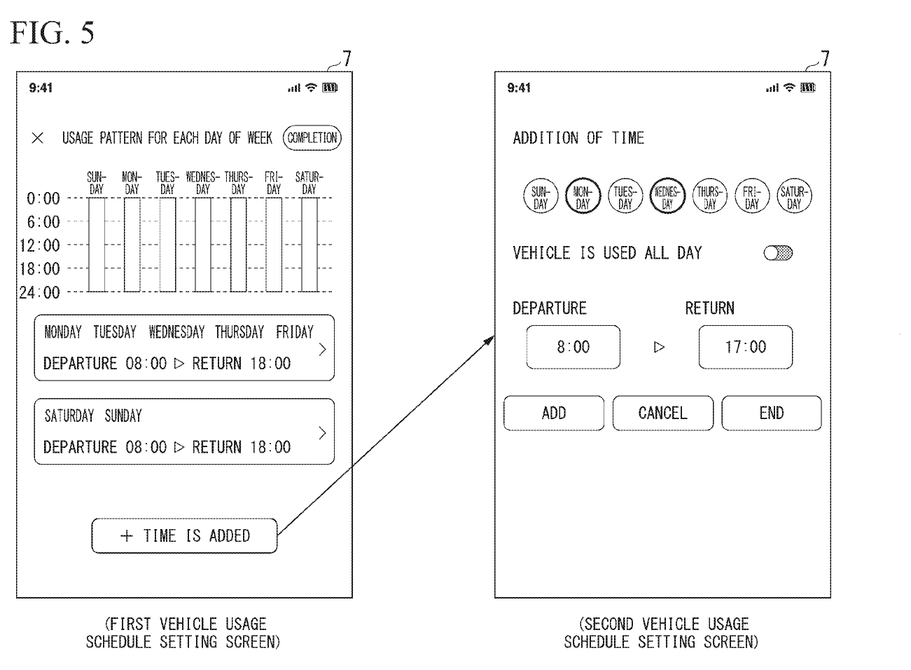

FIG. 5 is a diagram showing an example of the vehicle usage schedule setting screen displayed on the terminal device 7 according to the embodiment. On a first vehicle usage schedule setting screen, it is possible to set a vehicle usage time (a departure time and a return time) for weekdays (Monday to Friday) separately from a vehicle usage time (a departure time and a return time) for Saturday and Sunday. When an “add time” button provided on the first vehicle usage schedule setting screen is pressed, a second vehicle usage schedule setting screen is displayed. On this second vehicle usage schedule setting screen, it is possible to set a vehicle usage time for each day of the week.

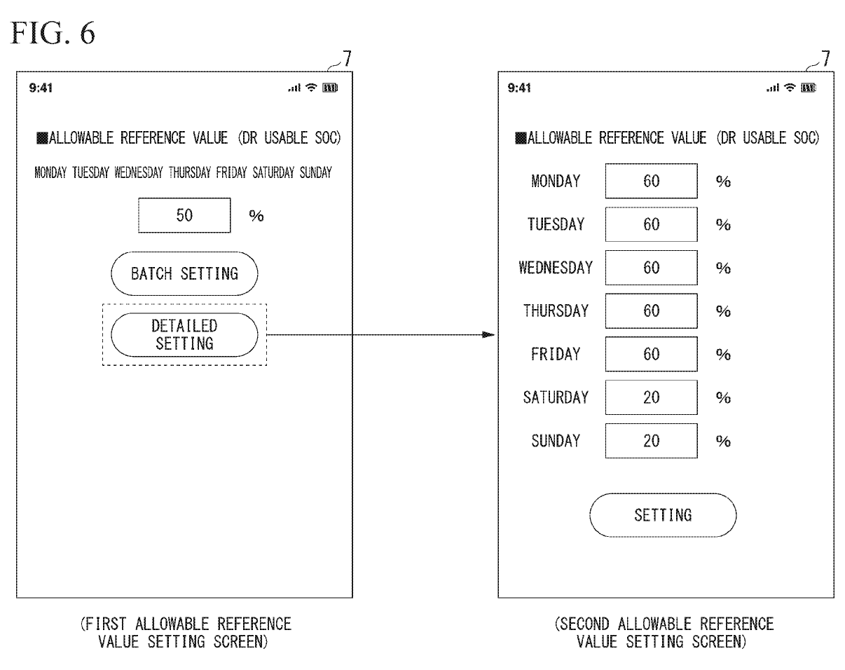

FIG. 6 is a diagram showing an example of the allowable reference value setting screen displayed on the terminal device 7 according to the embodiment. On the first allowable reference value setting screen, it is possible to set an allowable reference value (a single value) that is common to the entire period (from Monday to Sunday). When a “detailed setting” button provided on the first allowable reference value setting screen is pressed, a second allowable reference value setting screen is displayed. On this second allowable reference value setting screen, it is possible to set allowable reference values (a plurality of values) for any period, such as for each day of the week. In addition to this, an allowable reference value setting screen that allows the allowable reference values to be set for each time period may be used.

Returning to FIG. 4, the acquisition unit 11 acquires the vehicle usage schedule and the allowable reference value input by the user U via the terminal device 7 from the terminal device 7 (step S103).

Next, the vehicle usage management unit 12 associates the acquired vehicle usage schedule with the user U and sets the acquired vehicle usage schedule as the vehicle usage schedule D2 stored in the storage unit 30 (step S105). The allowable reference value setting unit 13 associates the acquired allowable reference value with the user U and sets the acquired allowable reference value as the allowable reference value D1 stored in the storage unit 30 (step S107). As a result, the processing of the present flowchart ends.

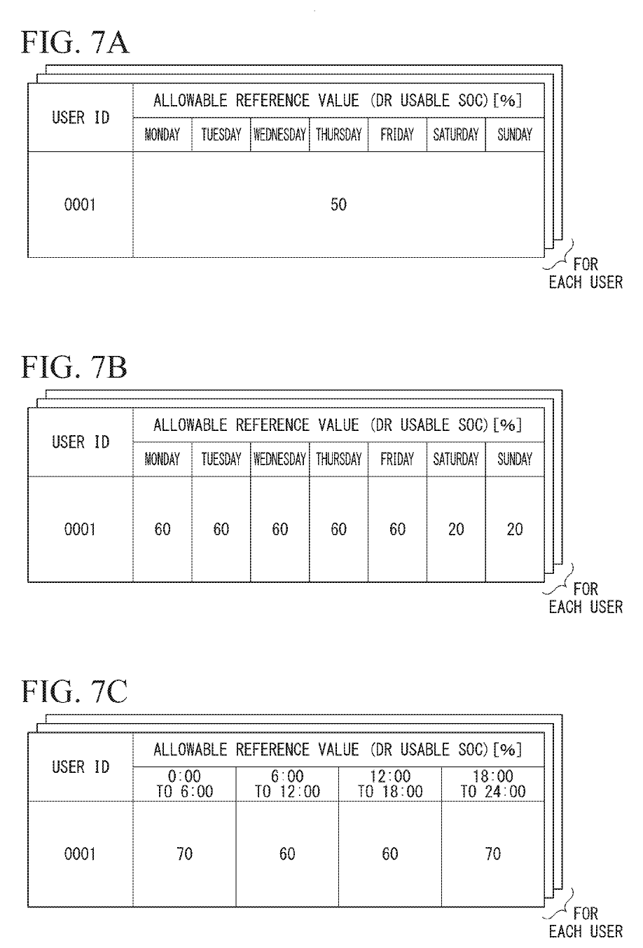

FIGS. 7A to 7C are diagrams showing an example of the allowable reference value D1 according to the embodiment. In the example of FIG. 7A, the allowable reference value (the DR usable SOC: “50%”) that is common to the entire period (from Monday to Sunday) is set in association with a user ID (“0001”), which is an identifier of the user U. In the example of FIG. 7B, the allowable reference value (the DR usable SOC: “60%”) for weekdays (Monday to Friday) is set, and the allowable reference value (the DR usable SOC: “20%”) for Saturday and Sunday is set in association with the user ID (“0001”), which is the identifier of the user U. In the example of FIG. 7C, the allowable reference values (the DR usable SOCs: “70%”, “60%”, “60%”, “70%”) are set for each time period (0:00 to 6:00, 6:00 to 12:00, 12:00 to 18:00, 18:00 to 24:00) in association with the user ID (“0001”), which is the identifier of the user U.

### DR Control Processing

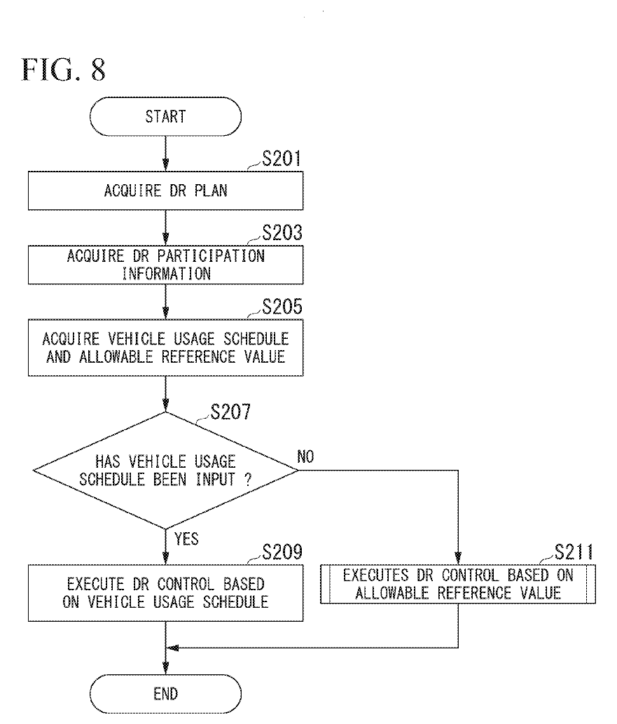

FIG. 8 is a flowchart showing an example of a flow of DR control processing of the charging and discharging management device 1 according to the embodiment. The processing shown in FIG. 8 is started, for example, at a predetermined timing when the DR control is executed. The following description will be given assuming that the allowable reference value D1 and the vehicle usage schedule D2 set by each user U have been already stored in the storage unit 30 of the charging and discharging management device 1. There are a plurality of vehicles M that are the targets of the DR control, and the charging and discharging management device 1 executes the following processing for each of these plurality of vehicles M.

First, the acquisition unit 11 acquires the DR plan transmitted from the electric utility device 3 (step S201). The acquisition unit 11 acquires information (hereinafter referred to as “DR participation information”) about a user of a vehicle that is in a state where the vehicle can participate in the DR control (a user of a vehicle of which the charging port is fitted to the charging plug of the charging and discharging device 5) from the charging/discharging device 5 (step S203). Furthermore, the acquisition unit 11 acquires each piece of information associated with the user included in the DR participation information from the allowable reference value D1 and the vehicle usage schedule D2 stored in the storage unit 30 (step S205).

Next, the determination unit 14 determines whether or not the vehicle usage schedule of the user U has been input, which is a determination target, on the basis of the acquired vehicle usage schedule (step S207). For example, the determination unit 14 determines whether or not the vehicle usage schedule of the user U on the day when the DR control is executed has been input.

In a case in which it is determined that the vehicle usage schedule has been input (S207: YES), the charging and discharging control unit 15 executes the DR control based on the vehicle usage schedule (step S209). For example, in a case in which the departure time is set to “8:00” and the return time is set to “17:00” as the vehicle usage schedule, the charging and discharging control unit 15 executes the DR control such that the vehicle does not participate in the DR control during the period from 8:00 to 17:00. The charging and discharging control unit 15 controls the charging and discharging of the battery B such that the state of charge of the battery B is equal to or greater than a predetermined value (so as to ensure the state of charge that does not affect the usage of the vehicle) at the departure time of “8:00.”

On the other hand, in a case in which it is determined that the vehicle usage schedule has not been input (S207: NO), the charging and discharging control unit 15 executes the DR control based on the allowable reference value (step S211).

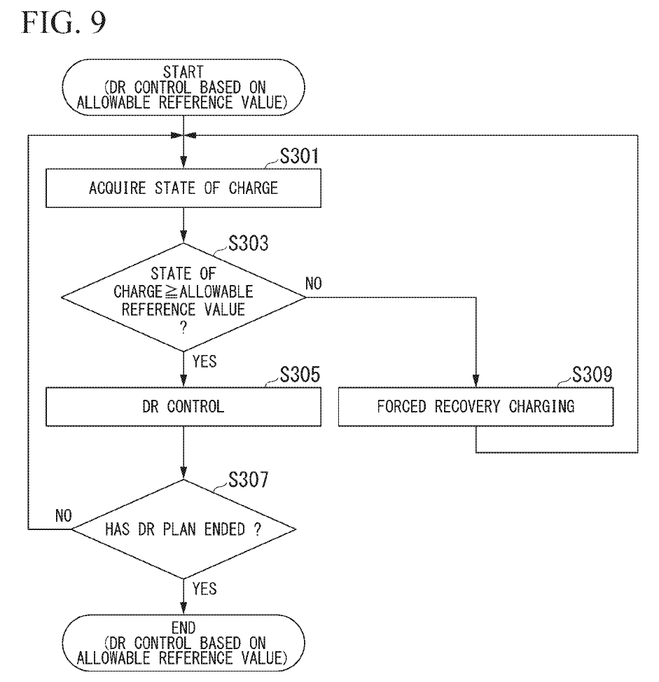

FIG. 9 is a flowchart showing an example of a flow of the DR control processing based on the allowable reference value (the processing of step S211 in FIG. 8) according to the embodiment. First, the acquisition unit 11 acquires information on the state of charge (SOC) of the battery B of the vehicle M from the vehicle M (or the charging and discharging device 5) (step S301).

Next, the charging and discharging control unit 15 determines whether the acquired state of charge (SOC) of the battery B of the vehicle M is equal to or greater than the allowable reference value associated with the user U of the vehicle M (step S303). In a case in which the allowable reference value is not set by the user U, the charging and discharging control unit 15 may perform the above determination using a predetermined reference value (for example, the SOC: 50% or the like) as the allowable reference value.

In a case in which it is determined that the state of charge (SOC) is equal to or greater than the allowable reference value (step S303: YES), it is determined that the condition of the allowable reference value set by the user U is satisfied (the state of charge of the battery B is sufficient). In this case, the charging and discharging control unit 15 performs the DR control incorporating the battery B of the vehicle M (step S305). For example, the charging and discharging control unit 15 charges the battery B in a case where control of the increasing DR is performed, and discharges the battery B when control of the decreasing DR is performed.

On the other hand, in a case in which it is determined that the state of charge (SOC) is not equal to or greater than the allowable reference value (step S303: YES), it is determined that the condition of the allowable reference value set by the user U is not satisfied (the state of charge of the battery B is insufficient). In this case, the charging and discharging control unit 15 controls such that the charging (the forced recovery charging) is performed until the state of charge of the battery B of the vehicle M reaches the allowable reference value (step S309). During this time, the battery B is excluded from the targets of the DR control. After the forced recovery charging is performed, the processing returns to step S301, and the subsequent processing is repeatedly executed. In a case in which, as a result of the forced recovery charging, the state of charge of the battery B is equal to or greater than the allowable reference value (step S303: YES), the charging and discharging control unit 15 performs the DR control under a condition in which the battery B is incorporated as a control target (step S305).

After step S305, the charging and discharging control unit 15 determines whether the DR plan has ended (whether the time set in the DR plan has elapsed). In a case in which it is determined that the DR plan has ended (step S307: YES), the processing of the present flowchart ends. On the other hand, in a case in which it is determined that the DR plan has not been ended (step S307: NO), the processing returns to step S301, and the subsequent processing is repeatedly executed.

Returning to FIG. 8, after the processing of step S209 or S211, the processing of the present flowchart ends.

The control based on the presence or absence of the vehicle usage schedule as described above is executed for the plurality of vehicles M simultaneously. In this case, the charging and discharging control unit 15 may perform adjustment such that a vehicle M, for which no vehicle usage schedule has been input, of a plurality of vehicles M has a higher priority for participating in the DR control (participating in the exchange of the electric power between the battery B of the vehicle M and the electric power grid).

According to the charging and discharging management device 1 of the embodiment described above, the battery B is charged until the state of charge of the battery B reaches the allowable reference value in a case in which the vehicle usage schedule has not been input and the state of charge of the battery B is less than the allowable reference value, and controls such that the exchange of the electric power between the battery B and the external electric power source is executed in a case in which the vehicle usage schedule has not been input and the state of charge of the battery B is equal to or greater than the allowable reference value, and thus it is possible to improve user convenience and resource utilization in controlling the DR. Even in a case in which the vehicle usage schedule has not been input by the user, the vehicle can be made to participate in the DR (or used as a spare resource), and thus it is possible to improve resource utilization rate. Since inputting the vehicle usage schedule is not a requirement for participating in the DR, it is possible to reduce the burden and stress on the user regarding the inputting. Since the minimum state of charge required for traveling is secured, it is possible to prevent any impact on subsequent use of the vehicle.

Although forms for carrying out the present invention have been described above using the embodiments, the present invention is not limited to these embodiments, and various modifications and substitutions can be made without departing from the gist of the present invention.

What is claimed is:

1. A charging and discharging management device comprising:
an acquisition unit that acquires input information on a vehicle usage schedule from a user of a vehicle, an allowable reference value which is set by the user and is a reference of a state of charge for whether or not to allow an exchange of electric power between a battery of the vehicle and an external electric power source, and a state of charge of the battery;
a determination unit that determines whether or not the vehicle usage schedule has been input on the basis of the input information; and
a charging and discharging control unit that controls charging and discharging of the battery to perform adjustment of an exchange of electric power between the battery and the external electric power source,
wherein the charging and discharging control unit
controls such that the battery is charged until the state of charge of the battery reaches the allowable reference value in a case in which the vehicle usage schedule has not been input and the state of charge of the battery is less than the allowable reference value, and
controls such that the exchange of the electric power between the battery and the external electric power source is executed preferentially in a case in which the vehicle usage schedule has not been input and the state of charge of the battery is equal to or greater than the allowable reference value.

2. The charging and discharging management device according to claim 1, wherein the allowable reference value is a single value set by the user.

3. The charging and discharging management device according to claim 1, wherein the allowable reference value includes a plurality of values set by the user for each period.

4. The charging and discharging management device according to claim 1, wherein the charging and discharging control unit performs the adjustment such that a vehicle, for which no vehicle usage schedule has been input, of a plurality of vehicles has a higher priority for participating in the exchange of the electric power between the battery and the external electric power source.

5. The charging and discharging management device according to claim 1, further comprising a remuneration management unit that manages a remuneration for the user according to a performance of participation in the exchange of the electric power between the battery and the external electric power source,
wherein the remuneration management unit provides a remuneration to the user in a case in which the vehicle is waiting to participate in a state where the vehicle is able to exchange electric power, and
wherein a remuneration in a case in which the vehicle is waiting to participate is lower than a remuneration in a case in which the vehicle has a performance of participation.

6. The charging and discharging management device according to claim 1, wherein, in a case in which the allowable reference value is not set by the user, the charging and discharging control unit performs the adjustment using a predetermined reference value as the allowable reference value.

7. The charging and discharging management device according to claim 1, wherein, in a case in which the vehicle usage schedule has been input, the charging and discharging control unit performs the adjustment on the basis of the vehicle usage schedule.

8. A charging and discharging management method causing a computer of a charging and discharging management device to execute:
acquiring input information on a vehicle usage schedule from a user of a vehicle, an allowable reference value which is set by the user and is a reference of a state of charge for whether or not to allow an exchange of electric power between a battery of the vehicle and an external electric power source, and a state of charge of the battery;
determining whether or not the vehicle usage schedule has been input on the basis of the input information;
controlling charging and discharging of the battery to perform adjustment of an exchange of electric power between the battery and the external electric power source;
controlling such that the battery is charged until the state of charge of the battery reaches the allowable reference value in a case in which the vehicle usage schedule has not been input and the state of charge of the battery is less than the allowable reference value; and
controlling such that the exchange of the electric power between the battery and the external electric power source is executed preferentially in a case in which the vehicle usage schedule has not been input and the state of charge of the battery is equal to or greater than the allowable reference value.
